(19) United States
(12) Patent Application Publication
(10) Pub. No.: US 2016/0034568 A1
(43) Pub. Date: Feb. 4, 2016

(54) Computer-Based Method of Processing of Machine-Readable Information

(71) Applicant: Alla Pavlovna TUZOVA, (US)

(72) Inventors: Vladimir Yaroslavovich Vasiljev, Vilnius (LT); Mark Sholemovich ZILBERMAN, Ontario (CA); Oleg Mikhailovich KISELEV, Essen (DE)

(21) Appl. No.: 14/655,399

(22) PCT Filed: Dec. 30, 2013
(86) PCT No.: PCT/RU2013/001208

§ 371 Date: Oct. 6, 2015

(30) Foreign Application Priority Data
Dec. 28, 2012 (RU) 2012158392

(51) Int. Cl. G06F 17/30

(52) U.S. Cl. CPC G06F 17/30696; G06F 17/30663; G06F 17/30684; G06F 17/30011

(57) ABSTRACT

The invention relates to processing of machine-readable data. The invention can be used for processing of data specially intended for a wide range of specific functions. The invention can be used in computers, for composing of computer programs, as well as for building systems of processing of information. Particular cases of using the invention include information search, processing of information in databases, data selection and its statistics. The invention can be used for receiving a visualized representation of data being processed, including data in the form of electronic documents. A computer-based method of processing of machine-readable data comprises: calling for a set of electronic documents; defining a search query; matching of search attributes to a search query; determining of matching of search attributes of electronic documents to specified search queries; attributing of electronic documents relevant to specified search queries to corresponding subject subsets of electronic documents.

### RELATED APPLICATIONS

The present invention is claims benefit of PCT/RU2013/001208, which is incorporated by reference as if fully rewritten herein.

### BACKGROUND OF THE INVENTION

The invention can also be used for processing of data with influence on order of location thereof. The invention can be used for processing of data specially intended for a wide range of specific functions. The invention can be used for manipulating of data in any form, including data presented in the natural language. The invention can be used in computers for composing of computer programs as well as building systems of processing of information. Particular cases of using the invention include information search, processing of information in databases, data selection and its statistics. The invention can be used for receiving a visualized representation of data being processed, including data in the form of electronic documents. The invention can be used for scientific research, as a learning instrument, or a visual aid. The invention can also be used as a game.

In the description, terms and definitions mostly used by specialists and in the technical literature on the given field of technology are used. However, the description of the invention has to use terms used ambiguously in a scientific and technical literature. The definitions of the most important terms used in the description of the invention are as follows:

Processing of information is performing of purposeful actions with machine-readable information;

Electronic document is any representation of information in an objective form at least part of which is machine-readable;

Search attribute of an electronic document is any machine-readable attribute of an electronic document (a rubric of classification, a keyword, a word in an electronic document, element, etc.);

Search query is an aggregate of search attributes for searching, selecting, sorting, grouping of electronic documents or attributing thereof;

Set of electronic documents is an aggregate of electronic documents;

Subset of electronic documents is an aggregate of electronic documents from a set of electronic documents. Subject subset of electronic documents is an aggregate of electronic documents chosen from a set according to a search query;

Non-empty subject subset of electronic documents is a subset of electronic documents that includes at least one document;

Empty subset of electronic documents is a subset of electronic documents that includes no electronic documents;

Screen is a part of a device intended for a visualized representation of information, such as a surface on which image is built in a cathode ray tube (CRT), liquid-crystal display (LCD), light-emitting diode (LED) or plasma panel or a surface on which image is built by a projector including when image is formed directly on a retina;

Visualizing on a screen is building of a visually discernible image representing information;

Visually isolated part of a screen is a part of a screen on which an image can be build isolated from other parts of a screen by visually discernible means such as contoured with a frame, has borders thereof shown, a background image, color of a field, borders, a frame, a title, or situated in a particular part of a screen in relation to borders thereof given that it is not distinguished by a background image, frames, or borders from an adjacent part of a screen, such as a top right corner of a screen or center thereof;

Box is a visually isolated part of a screen, contoured with a visually discernible frame, which represents a subject subset of electronic documents and is intended for containing areas representing electronic documents. A box can be varied in its size, form and color of a background, borders and other elements, some other properties of a visualized isolation. A box can be moved on a screen, minimized and maximized, represented by a symbol such as a label.

A box can be placed in different layers of an image on a screen, such as several boxes in a cascade. A box that does not contain areas representing electronic documents is rendered differently from a box that contains such areas. Boxes can be linked by lines such as for a representation of hierarchy of subject subsets;

Symbol is any sign assigned to a representation of any part of machine-readable information and/or representation of such information on a screen, such as a combination of letters or words, a number, any real or abstract image, etc;

Coordinates of borders of boxes are coordinates of each point of such borders;

Table is a two-dimensional structure sorting elements by placing them in rows and columns;

Territory is a visually isolated part of a screen allocated for visualizing of representations of electronic documents and representations of subject subsets of electronic documents;

Color code is information about color of a pixel on a screen, a machine-readable code with the help of which a colored image is unambiguously built on a screen. In the invented method, it is an additional property assigned to electronic documents and representations thereof, areas, subject subsets and representations thereof, boxes as well as database records for identifying thereof by such property and also visualizing on a screen;

Unique color code, uniquely combined color codes or a uniquely combined color code is information about a color of a pixel on a screen, a machine-readable non-repeated code with the help of which a colored image is unambiguously built on a screen. In the invented method, it is an additional property assigned to electronic documents and representations thereof, areas, subject subsets and representations thereof, boxes as well as database records for unambiguous identifying thereof by such property and also visualizing on a screen.

### DESCRIPTION OF THE PRIOR ART

It has previously been proposed to search information and select data from databases (RU 2236699, G06F 17/30, 20.09.2004) comprising: defining of at least one query by a user on a workplace, transferring of a user-defined query to a search engine, processing of user-defined search queries in a search engine by selecting documents from databases given that a search engine sorts the above-mentioned documents, calculates a rating for each sorted document, and then sorts the above-mentioned sorted documents taking into accounts rating thereof and transfers documents sorted in accordance with final rating thereof to a user workplace.

It has previously been proposed to search information with the help of an information search engine (RU 2266560, G06F 17/30, 20.12.2005) including: assigning order names to query vector terms, performing search with recording numbers of documents in computer memory with at least one term of query vector, number of terms, matched by query terms, is recorded in computer memory, as well as order numbers of matching terms, documents are sorted in computer memory in accordance to classes with even number of matching terms. Such methods of searching of information provide for only searching of text documents and positioning texts on keywords. A user has to find sentence snippets from the text manually.

It has previously been proposed to have a legal system of storing and search data (RU 2223537, G06F 17/30, 10.02.2004) comprising: a search type selection unit, a query generator, one output of which is linked to a search performing unit, input-output of which is linked through corresponding wires to system databases, a representation unit and a controller intended for control of information search, a search options selection unit, input of which is connected to output of a search type selection unit, the first output connected with input of a query generator, the second output connected to input of a filter attributes generator, the first input-output of which is connected to the second input-output of a query generator and the second input-output of which is connected to filter attributes memory unit, the first input-output of a query generator connected to a query memory unit.

Such system is complex and does not provide for viewing of intermediate and final results of processing of information given that a user has no immediate access to found sources for operative changing of a tactic of processing of information and a query.

At present, general search engines (Google, Yahoo, Yandex, etc.) and specialized information search engines (Garant, Konsultant+) are commonly used, object thereof being to search information including searching of documents according to a user query. A search engine can position the found text on a screen of a user monitor according to locations of keywords from a query. A user has to further analyze the text manually given that a user has no immediate access to found sources and viewing of intermediate and final results of processing of information.

It has previously been proposed to retrieve information from databases based on fuzzy reasoning. The proposed system provides the capability to assess if a database contains information pertinent to a subject of interest by evaluating each comment in the database via a fuzzy evaluator which attributes a fuzzy membership value indicating its relationship to such subject. (U.S. Pat. No. ,384,894, G06N 7/00; G06N 7/02; G06F 17/30; G06F 9/44; G06F 015/40; G06F 007/22; G06F 009/44; patented 24 Jan. 1995, assignee: International Business Machines Corp. Armonk, N.Y.).

This method of processing of machine-readable information does not provide for viewing of intermediate and final results thereof and possibility of quick navigation to any electronic document.

It has previously been proposed to process machine-readable information retrieved from databases as electronic documents. A database such as the Web is searched for occurrences of tuples of information. The occurrences of the tuples of information that were found in the database are analyzed to identify a pattern in which the tuples of information were stored. Additional tuples of information can then be extracted from the database utilizing the pattern. This process can be repeated with the additional tuples of information, if desired (U.S. Pat. No. 6,678,681, G06F 17/30, filed Sep. 3, 2000; patented 13 Jan. 2004, inventor: Brin; Sergey (Palo Alto, Calif.); assignee: Google Inc. (Mountain View, Calif.)). This method of processing of machine-readable information is a prototype of the invention.

Disadvantages of this method of processing of machine-readable information are its complexity, slow processing of information and orientation on traditional presentation of commands given that it does not provide for viewing of intermediate and final results thereof and a possibility of quick navigation to any electronic document.

It is an object of the invention to provide a method of quick processing of machine-readable information with a possibility of simultaneous accessibility of a large number of electronic documents. Another object of the invention is to quickly assign electronic documents to subject subsets of electronic documents. Yet another object of the invention is simultaneous visualization on a screen of intermediate and/or final results of processing of machine-readable information consisting of a large number of electronic documents. Yet another object of the invention is to quickly and efficiently operate electronic documents and subject subsets thereof as well as quick and efficient selection of search queries.

Other objects of the invention will become clear from a further text of a description of the invention.

### SUMMARY OF THE INVENTION

### AND

### TECHNICAL EFFECTS CREATED BY THE INVENTION

According to the spirit of the filed invention, there is provided a computer-based method of processing of machine-readable information in the form of electronic documents, comprising:
Calling for at least one set of electronic documents;
Defining at least one search query;
Matching of search attributes of electronic documents to at least one defined search query;
Determining of presence of search attributes in these electronic documents that are corresponded to one or several defined search queries;
Matching of each search query to its own unique subject subset of electronic documents given that each such search query is biunique only to one subject subset of electronic documents;
Attributing of electronic documents relevant to one or several defined search queries to such subject subset or such subject subsets of electronic documents, to which search query or search queries these electronic documents are relevant.

As a result of performing of the above-mentioned actions during processing of machine-readable information in the form of electronic documents, there is provided quick processing of machine-readable information in the form of a large number of electronic documents, differentiating of subject subsets of electronic documents relevant to various search queries or relevant to certain extent to one search query. Also, there is created an additional effect in case when electronic documents are relevant to several from the defined search queries; they being attributed to all the subject subsets of electronic documents that include the electronic documents which are relevant to the corresponded search query.

Also, there is provided an additional effect in case when search query can produce several types of answers as results. For example the search query for selecting of the text files contains 2 words and it is required to select the files containing both words. The subject subsets of found electronic documents (files) will be different for the cases when words are in consecutive order, are in one sentence but not in consecutive order, are in one paragraph, in various paragraphs, etc. given that some files can contain one occurrence and some files can contain a number of occurrences, some files can contain occurrences in various paragraphs, and some files can contain occurrences in one paragraph. The list of differentiating can be expanded. Each subject subset contains only files where use of words from a search query is identical. Each subject subset is formed and is accessible for viewing separately from others, and all subject subsets can be further processed.

In the invented method, there is provided a possibility of attributing of electronic documents relevant to one search query to a subject subset of electronic documents assigned to such search query.

As a result of attributing of electronic documents relevant to one search query to a subject subset of electronic documents assigned to such search query, there is provided a possibility of subject processing of electronic documents.

In the invented method, the electronic documents relevant to more than one search query can be attributed to each subject subset of electronic documents to search query of which (subject subset) electronic documents are relevant.

As a result of attributing of electronic documents relevant to more than one search query to each subject subset of electronic documents to which search query such electronic documents are relevant, there is provided a possibility of independent processing of each subject subset.

In the invented method, there is provided a possibility of calculating of a total number of non-empty subject subsets of electronic documents.

As a result of calculating of a total number of non-empty subject subsets of electronic documents, there is provided a possibility of preliminary and/or final evaluating of efficiency of an applied search query without considering in essence contents of subject subsets and electronic documents, correcting such search query, a possibility of statistic processing of machine-readable information as well as other possibilities of processing of machine-readable information without considering in essence contents of subject subsets and electronic documents that will become clear from a further description of the invention.

In the invented method, there is provided a possibility of calculating of a number of electronic documents attributed to each non-empty subject subset of electronic documents.

As a result of calculating of a number of electronic documents attributed to each non-empty subject subset of electronic documents, there is provided an additional possibility of preliminary and/or final evaluation of efficiency of a defined search query without considering in essence contents of electronic documents, correcting such search query, a possibility of statistic processing of machine-readable information as well as other possibilities of processing of machine-readable information.

In the invented method, there is provided a possibility of processing again of machine-readable information in the form of electronic documents contained in any subject subset of electronic documents as described in either claim 1, 2, 3, 4, or 5, or any combination thereof.

As a result of processing again of machine-readable information in the form of electronic documents contained in any subject subset of electronic documents as described in either claim 1, 2, 3, 4, or 5, or any combination thereof, there is provided deeper processing of machine-readable information.

In the invented method, there is provided a possibility of repeating two or more times as needed of such processing of machine-readable information as described in either claim 1, 2, 3, 4, or 5, or any combination thereof.

As a result of repeating two or more times as needed of such processing of machine-readable information as described in either claim 1, 2, 3, 4, or 5, or any combination thereof, there is provided deeper processing of machine-readable information and statistic information about machine-readable information being processed.

In the invented method, there is provided a possibility of visualizing on a screen of intermediate and/or final results of processing of machine-readable information with each non-empty subject subset of electronic documents as a separate box and each electronic document of such subject subset of electronic documents as an area within a corresponding box given that boxes and areas are rendered as separate objects of visualizing with properties changed while being visualized.

As a result of visualizing on a screen of intermediate and/or final results of processing of machine-readable information with each non-empty subject subset of electronic documents as a separate box and each electronic document of such subject subset of electronic documents as an area within a corresponding box given that boxes and areas are rendered as separate objects of visualizing with properties changed while being visualized, there is provided a visual representation on a screen of subject subsets of electronic documents and a representation of a large number of electronic documents attributed thereto.

Also, there is provided an additional effect when all the boxes can be visualized simultaneously given that they can completely fill a field of a screen allocated for a representation thereof, or if necessary only selected boxes can be visualized on a screen as needed. All the electronic documents contained within each box can be visualized, or if necessary only one box can be selected and all the electronic documents attributed to such subject subset of electronic documents will be visualized given that they completely fill a field of a box allocated for visualizing of electronic documents. The navigation to any such document for example for viewing can be immediate without scrolling of pages.

In the invented method, there is provided a possibility of visualizing on a screen of intermediate and/or final results of processing of machine-readable information as separate visually isolated parts of a screen.

As a result of visualizing on a screen of intermediate and/or final results of processing of machine-readable information as separate visually isolated parts of a screen such as separate boxes, there is provided improved visualizing of results of processing of machine-readable information and simplified possibility of further processing of machine-readable information.

In the invented method, there is provided a possibility of visualizing on a screen of each and/or any subject subset of electronic documents as a separate visually isolated part of a screen given that each visually isolated part of a screen is biunique only to one such representation of a subject subset of electronic documents.

As a result of visualizing on a screen of each and/or any subject subset of electronic documents as a separate visually isolated part of a screen given that each visually isolated part of a screen is biunique only to one such representation of a subject subset of electronic documents, there is provided a simplified possibility of further processing of machine-readable information.

In the invented method, there is provided a possibility of visualizing on a screen of each and/or any subject subset of electronic documents as one or more boxes given that each such box is biunique only to one such representation of a subject subset of electronic documents.

As a result of visualizing on a screen of each and/or any subject subset of electronic documents as one or more boxes given that each such box is biunique only to one such representation of a subject subset of electronic documents, there is provided a simplified possibility of further processing of machine-readable information contained in such subject subsets of electronic documents.

In the invented method, there is provided a possibility of assigning each and/or any visually isolated part of a screen visualizing a representation of each subject subset of electronic documents a temporary symbol such as a title or a number.

As a result of assigning each and/or any visually isolated part of a screen visualizing a representation of each subject subset of electronic documents a temporary symbol such as a title or a number, there is provided a simplified possibility of operating such subject subsets of electronic documents and information contained therein.

In the invented method, there is provided a possibility of assigning each and/or any box a temporary symbol such as a title or a number.

As a result of assigning each and/or any box a temporary symbol such as a title or a number, there is provided a simplified possibility of operating such boxes and information contained therein.

In the invented method, there is provided a possibility of using a number as the above-mentioned symbol of each and/or any representation of a subject subset of electronic documents.

As a result of using a number as the above-mentioned temporary symbol of each and/or any representation of a subject subset of electronic documents, there is provided a simplified possibility of operating such subject subsets of electronic documents and information contained therein.

In the invented method, there is provided a possibility of using a number in a part of a screen to which a box is assigned as the above-mentioned symbol of a box.

As a result of using a number in a part of a screen to which a box is assigned as the above-mentioned temporary symbol of a box, there is provided a simplified possibility of operating such boxes and information contained therein.

In the invented method, there is provided a possibility of using coordinates such as coordinates of location of subject subset of electronic documents in a part of a screen to which such subject subset of electronic documents is assigned as the above-mentioned symbol of a subject subset of electronic documents.

As a result of using coordinates such as coordinates of location of subject subset of electronic documents in a part of a screen to which such subject subset of electronic documents is assigned as the above-mentioned temporary symbol of a subject subset of electronic documents, there is provided a simplified possibility of operating such subject subsets of electronic documents and information contained therein.

In the invented method, there is provided a possibility of using coordinates of location of a box in a part of a screen to which such box is assigned as the above-mentioned symbol of a box.

As a result of using coordinates of location of a box in a part of a screen to which such box is assigned as the above-mentioned symbol of a box, there is provided a simplified possibility of operating such boxes and information contained therein.

In the invented method, there is provided a possibility of visualizing of representations of subject subsets of electronic documents within a corresponding part of a screen as a table.

As a result of visualizing of representations of subject subsets of electronic documents within a corresponding part of a screen as a table, there is provided a simplified possibility of operating such subject subsets of electronic documents and information contained therein.

In the invented method, there is provided a possibility of visualizing of boxes within a corresponding part of a screen as a table.

As a result of visualizing of representations of boxes within a corresponding part of a screen as a table, there is provided a simplified possibility of operating such subject subsets of electronic documents and information contained therein, a simplified possibility of operating of these boxes, in particularly to order and to sort boxes and information contained therein.

In the invented method, there is provided a possibility of visualizing of representations of subject subsets of electronic documents on a screen as a visually isolated part of a screen, called a territory, given that coordinates of borders of visualizing of representations of subject subsets of electronic documents can be calculated taking into account borders of a territory allocated for visualizing of representations of subject subsets of electronic documents.

As a result of visualizing of representations of subject subsets of electronic documents on a screen as a visually isolated part of a screen, called a territory, given that coordinates of borders of visualizing of representations of subject subsets of electronic documents are calculated taking into account borders of a territory allocated for visualizing of representations of subject subsets of electronic documents, there is provided a possibility of selecting optimal scale for representations of subject subsets of electronic documents visualized on a screen.

Also, there is an additional effect of visual isolating of a part of a screen not filled with representations of subject subsets for placing of other information within it such as descriptions of subject subsets of electronic documents and/or snippets from electronic documents.

In the invented method, there is provided a possibility of visualizing of boxes on a screen as a visually isolated part of a screen, called a territory, given that coordinates of borders of visualizing of representations of boxes are calculated taking into account borders of a territory allocated for locating of boxes.

As a result of visualizing of boxes on a screen as a visually isolated part of a screen, called a territory, given that coordinates of borders of visualizing of representations of boxes are calculated taking into account borders of a territory allocated for locating of boxes, there is provided a possibility of selecting optimal scale for boxes visualized on a screen.

Also, there is an additional effect of visual isolating of a part of a screen not filled with boxes for placing of other information within it such as descriptions of boxes and/or snippets of electronic documents.

In the invented method, there is provided a possibility of visualizing on a screen of each representation of an electronic document relevant to at least one search query and attributed to at least one subject subset of electronic documents as a separate visually isolated part of a screen within a box, called area, wherein all the representations of electronic documents attributed to such subject subset of electronic documents are visualized.

As a result of visualizing on a screen of each representation of an electronic document relevant to at least one search query and attributed to at least one subject subset of electronic documents as a separate visually isolated part of a screen within a box, called area, wherein (in box) all the representation of electronic documents attributed to such subject subset of electronic documents are visualized, there is provided simultaneous visibility of all the representations of electronic documents attributed to such subject subset of electronic documents and a possibility of operating of any such representation of an electronic document.

Also, there is an additional effect when navigation to any document represented as an area within a box for example for viewing can be done immediately without scrolling of pages.

In the invented method, there is provided a possibility of visualizing on a screen of each and/or any representation of an electronic document as a box given that each box is biunique only to one representation of electronic documents relevant to one search query and attributed to a subject subset of electronic documents to which such search query is assigned.

As a result of visualizing on a screen of each and/or any representation of an electronic document as a box given that each box is biunique only to representations of electronic documents relevant to one search query and attributed to a subject subset of electronic documents to which such search query is assigned, there is provided a possibility of working only with representations of these electronic documents.

In the invented method, there is provided a possibility of visualizing on a screen of each and/or any representation of an electronic document as one or more boxes given that electronic documents relevant to more than one search query are attributed to each subject subset of electronic documents to search queries of which these electronic documents are relevant and are visualized in each box corresponding to these subject subsets of electronic documents.

As a result of visualizing on a screen of each and/or any representation of an electronic document as one or more boxes given that electronic documents relevant to more than one search are attributed to each subject subset of electronic documents to search queries of which these electronic documents are relevant and are visualized in each box corresponding to these subject subsets of electronic documents, there is provided a possibility of working only with representations of such electronic documents

In the invented method, there is provided a possibility of assigning each and/or any representation of an electronic document a temporary symbol such as a title or a number.

As a result of assigning each and/or any representation of an electronic document a temporary symbol such as a title or a number, there is provided simplified and accelerated working with representations of such electronic documents.

In the invented method, there is provided a possibility of using a number of electronic document in a box to which such representation of an electronic document is assigned as the above-mentioned temporary symbol of a representation of an electronic document.

As a result of using a number of electronic document in a box to which such representation of an electronic document is assigned as the above-mentioned temporary symbol of a representation of an electronic document, there is provided simplified and accelerated working with representations of such electronic documents.

In the invented method, there is provided a possibility of using coordinates of location of a representation of electronic document within a box to which such representation of electronic document is assigned as the above-mentioned temporary symbol of a representation of electronic document.

As a result of using coordinates of location of a representation of electronic document within a box to which such representation of electronic document is assigned as the above-mentioned temporary symbol of a representation of electronic document, there is provided simplified and accelerated working with representations of such electronic documents.

In the invented method, there is provided a possibility of visualizing of representations of electronic documents within a box as a table.

As a result of visualizing of representations of electronic documents within a box as a table, there is provided simplified and accelerated working with representations of such electronic documents and simplified working with hierarchical ordering thereof.

In the invented method, there is provided a possibility of visualizing of all the representations of electronic documents attributed to one and the same subject subset of electronic documents within a corresponding box as separate visually isolated parts of a screen, called areas.

As a result of visualizing of all the representations of electronic documents attributed to one and the same subject subset of electronic documents within a corresponding box as separate visually isolated parts of a screen, called areas, there is provided simplified and accelerated working with representations of such electronic documents, simplified changing of borders of areas visualizing such representations of electronic documents, and a possibility of location of all such representations of electronic documents within a single box is arised.

In the invented method, there is provided a possibility of visualizing of all the representations of electronic documents attributed to one and the same subject subset of electronic documents within a corresponding box as separate visually isolated parts of a screen, called areas, given that coordinates of borders of boxes are calculated taking into account borders of a part of a box allocated for locating of areas.

As a result of visualizing of all the representations of electronic documents attributed to one and the same subject subset of electronic documents within a corresponding box as separate visually isolated parts of a screen, called areas, given that coordinates of boxes are calculated taking into account borders of a part of a box allocated for locating of areas, there is provided a possibility of selecting optimal scale for a representation of subject subsets of electronic documents visualized on a screen.

Also, there is an additional effect of isolating of a part of a box not filled with areas for placing other information within it such as descriptions of electronic documents and/or snippets from electronic documents and/or titles of electronic documents, etc.

In the invented method, there is provided a possibility of visualizing of all the representations of electronic documents attributed to one and the same subject subset of electronic documents within a corresponding box as separate visually isolated parts of a screen, called areas.

As a result of visualizing of all the representations of electronic documents attributed to one and the same subject subset of electronic documents within a corresponding box as separate visually isolated parts of a screen, called areas, there is provided simplified and accelerated working with all the representations of such electronic documents and all documents visualized as areas.

In the invented method, there is provided a possibility of complete filling of borders of at least part of a box allocated for locating of areas with such areas.

As a result of complete filling of borders of at least part of box allocated for locating of areas with such areas, there is provided full visibility of all the representations of such electronic documents and a possibility of working with any electronic document.

In the invented method, there is provided a possibility of filling of the above-mentioned borders of only part of the above-mentioned areas with such part of the above-mentioned areas visualized within a box and other part of the above-mentioned areas not visualized within a box given that there is provided a possibility of moving the above-mentioned areas for visualizing of any combination of the above-mentioned areas.

As a result of filling of the above-mentioned borders of only part of the above-mentioned areas with such part of the above-mentioned areas visualized within a box and other part of the above-mentioned areas not visualized within a box given that there is provided a possibility of moving the above-mentioned areas for visualizing of any combination of the above-mentioned areas, there is provided a possibility of quick viewing of any representation of such electronic documents and quick navigation to working with any such electronic document.

In the invented method, there is provided a possibility of decreasing or increasing size of the above-mentioned areas during the processing of machine-readable information.

As a result of decreasing or increasing size of the above-mentioned areas during the processing of machine-readable information, there is provided a possibility of selecting optimal scale thereof and viewing a necessary number of areas.

In the invented method, there is provided a possibility of filling borders of at least part of a box allocated for placing of the above-mentioned areas with such areas in accordance with defined rules of placing of such areas within a box.

As a result of filling borders of at least part of a box allocated for placing of the above-mentioned areas with such areas in accordance with defined rules of placing of such areas within a box, there is provided a possibility of convenient viewing of only such areas and working with any such area.

In the invented method, there is provided a possibility of visualizing of all the representations of electronic documents attributed to one and the same subject subset of electronic documents within a corresponding box as separate visually isolated parts of a screen, called areas, given that at least part of a box allocated for placing of areas is filled with such areas in accordance with defined rules of placing of areas within a box.

As a result of visualizing of all the representations of electronic documents attributed to one and the same subject subset of electronic documents within a corresponding box as separate visually isolated parts of a screen, called areas, given that at least part of a box allocated for placing of areas is filled with such areas in accordance with defined rules of placing of areas within a box, there is provided a possibility of convenient viewing of these areas and working with any such area.

In the invented method, there is provided a possibility of calculating of size and borders of each area within borders of at least part of a box allocated for placing of areas taking into account borders of a box, a number of areas, and defined rules of placing of areas within a box.

As a result of calculating of size and borders of each area within borders of at least part of a box allocated for placing of areas taking into account borders of a box, a number of areas, and defined rules of placing of areas within a box, there is provided a possibility of convenient viewing of these areas and working with any such area.

In the invented method, there is provided a possibility of assigning each electronic document and/or a representation of an electronic document a unique color code.

As a result of assigning each electronic document and/or a representation of an electronic document a unique color code, there is provided accelerated identifying of an electronic document and/or a representation thereof, simplified visualizing on a screen of an representation of electronic document.

In the invented method, there is provided a possibility of assigning each electronic document and/or a representation of an electronic document at least two uniquely combined color codes.

As a result of assigning each electronic document and/or a representation of an electronic document at least two uniquely combined color codes, there is provided accelerated identifying of an electronic document and/or a representation thereof, simplified visualizing on a screen of an electronic document, increasing of a maximum number of objects which can be identified by color codes in a chosen set of electronic documents such as a database.

In the invented method, there is provided a possibility of assigning each electronic document relevant to one or several defined search queries and/or a representation of such electronic document a unique color code or uniquely combined color codes.

As a result of assigning each electronic document relevant to one or several defined search queries and/or a representation of such electronic document a unique color code or uniquely combined color codes, there is provided improved evaluating of efficiency of selecting search queries, accelerated identifying of an electronic document and/or a representation thereof, simplified visualizing on a screen of a representation of an electronic document.

In the invented method, there is provided a possibility of assigning of a unique color code or uniquely combined color codes to only electronic documents relevant to one or several defined search queries and/or a representations of such electronic documents.

As a result of assigning of a unique color code or uniquely combined color codes to only electronic documents relevant to one or several defined search queries and/or a representations of such electronic documents, there is provided improved evaluating of efficiency of selecting search queries, accelerated identifying of an electronic document and/or a representation thereof, simplified visualizing on a screen of a representation of an electronic document.

In the invented method, there is provided a possibility of visualizing on a screen of intermediate and/or final results of processing of machine-readable information with each area or each visually isolated part of a screen visualizing a corresponding representation of an electronic document colored according to a unique color code assigned to such electronic document or uniquely combined color codes assigned to such electronic document and/or a representation thereof.

As a result of visualizing on a screen of intermediate and/or final results of processing of machine-readable information with each area or each visually isolated part of a screen visualizing a corresponding representation of an electronic document colored according to a unique color code assigned to such electronic document or uniquely combined color codes assigned to such electronic document and/or a representation thereof, there is provided improved efficiency of selecting search queries, accelerated identifying of an electronic document and/or a representation thereof, simplified visualizing on screen of a representation of an electronic document.

In the invented method, there is provided a possibility of assigning a unique color code to at least one box.

As a result of assigning a unique color code to at least one box, there is provided improved efficiency and visualizing of processing of machine-readable information.

In the invented method, there is provided a possibility of assigning a unique color code to background of at least one box.

As a result of assigning a unique color code to background of at least one box, there is provided improved efficiency and visualizing of processing of machine-readable information.

In the invented method, there is provided a possibility of assigning a unique color code to borders of at least one box.

As a result of assigning a unique color code to borders of at least one box, there is provided improved efficiency and visualizing of processing of machine-readable information.

In the invented method, there is provided a possibility of visualizing on a screen of intermediate and/or final results of processing of machine-readable information with background and/or borders of at least one box colored according to a unique color code assigned to such box.

As a result of visualizing on a screen of intermediate and/or final results of processing of machine-readable information with background and/or borders of at least one box colored according to a unique color code assigned to such box, there is provided improved efficiency and visualizing of processing of machine-readable information.

In the invented method, there is provided a possibility of assigning a unique color code to each subject subset of electronic documents.

As a result of assigning a unique color code to each subject subset of electronic documents, there is provided improved efficiency and visualizing of processing of machine-readable information.

In the invented method, there is provided a possibility of assigning of two or more uniquely combined color codes to each subject subset of electronic documents.

As a result of assigning of two or more uniquely combined color codes to each subject subset of electronic documents, there is provided improved efficiency and visualizing of processing of machine-readable information.

In the invented method, there is provided a possibility of assigning of a unique color code or uniquely combined color codes to each non-empty subject subset of electronic documents.

As a result of assigning of a unique color code or uniquely combined color codes to each non-empty subject subset of electronic documents, there is provided improved efficiency and visualizing of processing of machine-readable information.

In the invented method, there is provided a possibility of assigning of a unique color code or uniquely combined color codes to only non-empty subject subsets of electronic documents.

As a result of assigning of a unique color code or uniquely combined color codes to only non-empty subject subsets of electronic documents, there is provided improved efficiency and visualizing of processing of machine-readable information.

In the invented method, there is provided a possibility of visualizing on a screen of intermediate and/or final results of processing of machine-readable information with areas within a box visualizing representations of electronic documents relevant to at least one search query colored in a corresponding color.

As a result of visualizing on a screen of intermediate and/or final results of processing of machine-readable information with areas within a box visualizing representations of electronic documents relevant to at least one search query colored in a corresponding color, there is provided improved efficiency and visualizing of processing of machine-readable information.

In the invented method, there is provided a possibility of visualizing on a screen of intermediate and/or final results of processing of machine-readable information with areas within boxes visualizing representations of electronic documents relevant to at least one defined search query by positioning of one from available cursors over such areas and performing of previously defined commands while positioning of a cursor in an operator-defined sequence for a visualized viewing of at least part of information contained in electronic documents, and/or at least part of properties of corresponding electronic documents, and/or performing of a previously defined sequence of actions with corresponding electronic documents which representations are visualized by such areas.

As a result of visualizing on a screen of intermediate and/or final results of processing of machine-readable information with areas within boxes visualizing representations of electronic documents relevant to at least one defined search query selected by positioning of one from available cursors over such areas and performing of previously defined commands while positioning of a cursor in an operator-defined sequence for a visualized viewing of at least part of information contained in electronic documents, and/or at least part of properties of corresponding electronic documents, and/or performing of a previously defined sequence of actions with corresponding electronic documents which representations are visualized by such areas, there is provided improved efficiency and visualizing of processing of machine-readable information.

In the invented method, there is provided a possibility of a visualized viewing of at least part of information contained in any such electronic document, and/or at least part of properties of a corresponding electronic document, and/or performing of a previously defined sequence of actions with a corresponding electronic document automatically moved to each consequent area within a box visualizing a consequent representation of other electronic document after an operator-defined time intervals.

As a result of visual viewing of at least part of information contained in any such electronic document and/or at least part of properties of a corresponding electronic document and/or performing of a previously defined sequence of actions with a corresponding electronic document automatically moved to each consequent area within a box visualizing a consequent representation of other electronic document after an operator-defined time intervals, there is provided improved and accelerated processing of machine-readable information.

In the invented method, there is provided a possibility of an automatic move to a consequent area visualizing a representation of an electronic document by order or to an area visualizing a representation of an electronic document by other operator-defined choice rule.

As a result of an automatic move to a consequent area visualizing a representation of an electronic document by order or to an area visualizing a representation of an electronic document by other operator-defined choice rule, there is provided improved and accelerated processing of machine-readable information.

In the invented method, there is provided a possibility of an automatic move after an operator-defined time interval to a consequent area visualizing a representation of an electronic document being paused and/or continued by an operator command such as pressing a certain key on a keyboard.

As a result of an automatic move after an operator-defined time interval to a consequent area visualizing a representation of an electronic document being paused and/or continued by an operator command such as pressing a certain key on a keyboard, there is provided improved and accelerated processing of machine-readable information.

In the invented method, there is provided a possibility of an automatic move to a consequent area visualizing a representation of an electronic document by an operator command being paused and/or continued, and/or having direction of a visualized viewing changed, and/or having time interval changed for an automatic move to other area visualizing a representation of an electronic document, and/or having choice rule changed for other area visualizing a representation of an electronic document, and/or having subject changed for visualizing of information related to an electronic document, and/or having a previously defined sequence of actions with a corresponding electronic document changed.

As a result of an automatic move to a consequent area visualizing a representation of an electronic document by an operator command being paused and/or continued, and/or having direction of a visualized viewing changed, and/or having time interval changed for an automatic move to other area visualizing a representation of an electronic document, and/or having choice rule changed for other area visualizing a representation of an electronic document, and/or having subject changed for visualizing of information related to an electronic document, and/or having a previously defined sequence of actions with a corresponding electronic document changed, there is provided improved and accelerated processing of machine-readable information.

In the invented method, there is provided a possibility of visualizing of at least part of information contained in an electronic document chosen by an operator for a visualized viewing within a special visually isolated part of a screen.

As a result of visualizing of at least part of information contained in an electronic document chosen by an operator for a visualized viewing within a special visually isolated part of a screen, there is provided improved and accelerated processing of machine-readable information.

In the invented method, there is provided a possibility of visualizing of information contained in an electronic document chosen by an operator for a visualized viewing within a special visually isolated part of a screen in a previously defined scope for a visualized viewing.

As a result of visualizing of information contained in an electronic document chosen by an operator for a visualized viewing within a special visually isolated part of a screen in a previously defined scope for a visualized viewing, there is provided improved and accelerated processing of machine-readable information.

In the invented method, there is provided a possibility of visualizing of at least part of information contained in an electronic document chosen for viewing within a special visually isolated part of a screen in a previously defined format.

As a result of visualizing of at least part of information contained in an electronic document chosen for viewing within a special visually isolated part of a screen in a previously defined format, there is provided improved and accelerated processing of machine-readable information.

In the invented method, there is provided a possibility of visualizing of at least part of information contained in an electronic document chosen for a visualized viewing being retrieved from a previously defined part of an electronic document in a previously defined scope and is visualized on a screen within a special visually isolated part of a screen in a previously defined format for a visualized viewing.

As a result of visualizing of at least part of information contained in an electronic document chosen for a visualized viewing being retrieved from a previously defined part of an electronic document in a previously defined scope and is visualized on a screen within a special visually isolated part of a screen in a previously defined format for a visualized viewing, there is provided improved and accelerated processing of machine-readable information.

In the invented method, there is provided a possibility of visualizing of any visualized on a screen as areas within boxes, visually isolated parts of a screen, intermediate or final results of processing of machine-readable data, representations of electronic documents relevant to at least one defined search query being accompanied with the help of positioning of one from available cursors over the chosen area chosen, such as chosen by an operator, by the following actions or any combination thereof:

Viewing of at least part of information contained in any such document in a previously defined scope and in a previously defined format of a representation of such information within a special visually isolated a part of a screen,

Viewing of any such document,

Viewing of properties of any such document,

Attributing of at least one additional property to any such document,

Modifying of at least one property of any such document,

Copying of a representation of any such document,

Duplicating of a representation of any such document,

Moving of a representation of any such document,

Deleting of a representation of any such document.

As a result of performing of any above-mentioned action or any combination thereof, there is provided improved and accelerated processing of machine-readable information.

In the invented method, there is provided a possibility of choosing of at least one visualized on a screen as an area within a box, separate visually isolated parts of a screen, intermediate or final results of processing of machine-readable data, electronic documents relevant to at least one defined search query being performed with the help of positioning of one from available cursors over a corresponding area within a box assigned for a chosen result and/or a representation of an electronic document.

As a result of choosing of at least one visualized on a screen as an area within a box, separate visually isolated parts of a screen, intermediate or final results of processing of machine-readable data, electronic documents relevant to at least one defined search query being performed with the help of positioning of one from available cursors over a corresponding area within a box assigned for a chosen result and/or a representation of an electronic document, there is provided improved and accelerated processing of machine-readable information.

In the invented method, there is provided a possibility of positioning of one from available cursors within an operator-defined time interval.

As a result of positioning of one from available cursors within an operator-defined time interval, there is provided improved and accelerated processing of machine-readable information.

In the invented method, there is provided a possibility of choosing of an object by positioning of one from available cursors and pressing a previously defined key on a keyboard.

As a result of choosing of an object by positioning of one from available cursors and pressing a previously defined key on a keyboard, there is provided improved and accelerated processing of machine-readable information.

In the invented method, there is provided a possibility of choosing of an object by positioning of one from available cursors and pressing a previously defined mouse button.

As a result of choosing of an object by positioning of one from available cursors and pressing a previously defined mouse button, there is provided improved and accelerated processing of machine-readable information.

In the invented method, there is provided a possibility of choosing of an object by positioning of one from available cursors and pressing a previously defined key or a combination of keys on a previously defined manipulator.

As a result of choosing of an object by positioning of one from available cursors and pressing a previously defined key or a combination of keys on a previously defined manipulator, there is provided improved and accelerated processing of machine-readable information.

In the invented method, there is provided a possibility when each and/or any representation of electronic documents being visualized on a screen as a separate visually isolated part of a screen within a box, or area, not colored, and/or having borders thereof not colored, and/or having no visually distinguishable captions over such area, and differentiated from other similar areas only by coordinates of borders thereof and location within a box.

As a result when each and/or any representation of electronic documents being visualized on a screen as a separate visually isolated part of a screen within a box, or area, not colored, and/or having borders thereof not colored, and/or having no visually distinguishable captions over such area, and differentiated from other similar areas only by coordinates of borders thereof and location within a box, there is provided enhanced visualizing of results of processing of machine-readable information in combination with visualizing other non-processed information.

In the invented method, there is provided a possibility of each and/or any area within a box visualizing on a screen of representations of electronic documents as a separate visually isolated part of a screen being not colored, and/or having borders thereof not colored, and/or having no visually discernible captions over such area, and differentiated from other similar areas only by coordinates of borders thereof and location within a box.

As a result of each and/or any area within a box visualizing on a screen representations of electronic documents as a separate visually isolated part of a screen being not colored, and/or having borders thereof not colored, and/or having no visually discernible captions over such area, and differentiated from other similar areas only by coordinates of borders thereof and location within a box, there is provided enhanced visualizing of results of processing of machine-readable information in combination with visualizing other non-processed information.

In the invented method, there is provided a possibility of at least one set of electronic documents called for during processing of machine-readable information being a database.

As a result, there is provided a possibility of efficient processing of machine-readable information in a database, enhanced possibilities of processing of information with the help of standard methods of processing of information in databases.

In the invented method, there is provided a possibility of assigning each record of a database a unique color code.

As a result of assigning each record of a database a unique color code, there is provided improved visualizing and efficiency of processing of machine-readable information in database, enhanced possibilities of processing of information with the help of standard methods of processing of information in databases, simplified and accelerated processing of information.

In the invented method, there is provided a possibility of assigning each record of a database at least two uniquely combined color codes.

As a result of assigning each record of a database at least two uniquely combined color codes, there is provided improved visualizing and efficient processing of machine-readable information in databases, enhanced possibilities of processing of information with the help of standard methods of processing of information in databases, simplified and accelerated processing of information.

In the invented method, there is provided a possibility of visualizing of at least part of properties of an electronic document chosen by an operator for a visualized viewing within a special visually isolated part of a screen.

As a result of visualizing of at least part of properties of an electronic document chosen by an operator for a visualized viewing within a special visually isolated part of a screen, there is provided improved visualizing and efficient processing of machine-readable information.

In the invented method, there is provided a possibility of visualizing of information about properties of an electronic document chosen by an operator for a visualized viewing within a special visually isolated part of a screen in a previously defined scope for a visualized viewing.

As a result of visualizing of information about properties of an electronic document chosen by an operator for a visualized viewing within a special visually isolated part of a screen in a previously defined scope for a visualized viewing, there is provided accelerated visualizing and efficient processing of machine-readable information.

In the invented method, there is provided a possibility of visualizing of at least part of properties of an electronic document chosen by an operator for viewing within a special visually isolated part of a screen in a previously defined format.

As a result of visualizing of at least part of properties of an electronic document chosen by an operator for viewing within a special visually isolated part of a screen in a previously defined format, there is provided accelerated visualizing and efficient processing of machine-readable information.

In the invented method, there is provided a possibility of visualizing of at least part of properties of an electronic document chosen for a visualized viewing retrieved from a previously defined part of an electronic document and/or other source of information about properties of a chosen electronic document in a previously defined scope within a special visually isolated part of a screen in a previously defined format for a visualized viewing.

As a result of visualizing of at least part of properties of an electronic document chosen for a visualized viewing retrieved from a previously defined part of an electronic document and/or other source of information about properties of a chosen electronic document in a previously defined scope within a special visually isolated part of a screen in a previously defined format for a visualized viewing, there is provided accelerated visualizing and efficient processing of machine-readable information.

In the invented method, there is provided a possibility of visualizing of intermediate and/or final results of processing of machine-readable information on a screen with each non-empty subject subset of electronic documents as a separate box and each electronic document of such subject subset of electronic documents as a separate area within a corresponding box given that boxes and areas are rendered as separate visualized objects having properties thereof changed while being visualized.

As a result of visualizing of intermediate and/or final results of processing of machine-readable information on a screen with each non-empty subject subset of electronic documents as a separate box and each electronic document of such subject subset of electronic documents as a separate area within a corresponding box given that boxes and areas are rendered as separate visualized objects having properties thereof changed while being visualized, there is provided improved visualizing and efficient processing of machine-readable information, simplified visualizing of results of processing.

In the invented method, there is provided a possibility of visualizing of intermediate and/or final results of processing of machine-readable information on a screen with showing each non-empty subject subset.

As a result of visualizing of intermediate and/or final results of processing of machine-readable information on a screen with showing each non-empty subject subset, there is provided simplified visualizing of results of processing.

### EXAMPLES OF THE BEST POSSIBILITIES OF USING OF THE INVENTION

In the invented method, performing of processing of machine-readable information is illustrated with the following examples:

### Example 1

Processing of machine-readable information in the form of electronic documents without visualizing on a screen of intermediate and/or final results of such processing.

### Example 2

Processing of machine-readable information in the form of electronic documents accompanied by visualizing on a screen of intermediate and/or final results of such processing.

### Example 3

Processing of machine-readable information in the form of electronic documents accompanied by visualizing on a screen of intermediate and/or final results of such processing and using color codes.

### Example 4

Processing of machine-readable information in the form of electronic documents by means of automatic actions and/or operator-defined commands.

In the invented method, below described are examples of processing of machine-readable information in the form of electronic documents.

### Example 1

Processing of machine-readable information in the form of electronic documents without visualizing on a screen of intermediate and/or final results of such processing.

Processing of machine-readable information in the form of electronic documents is performed in computers and information systems comprising computers.

For practical purposes of the description of the invention, an electronic document (thereafter referred to as electronic documents, documents) is defined in a broad sense as any viewed as a whole discernible by a computer in at least some part existing records in any type of memory accessed by a computer such as temporary values of memory registers, records on hard drives, punched tapes, punched cards, et.

Any group of electronic documents forms a set of electronic documents. If a set contains no documents, it is defined as an empty set.

The case of a set containing no documents and/or containing itself as a subset is not excluded here for practical purposes of the description of the invention.

For practical purposes of the description of the invention, each set is assumed as containing at least one subset, i.e. at least containing itself as a subset.

For practical purposes of the description of the invention, process of processing of machine-readable information in the form of electronic documents is assumed to have an initial event, some intermediate events and a final event such as some event is arbitrarily assumed to be an initial event, some events is arbitrarily assumed to be an intermediate events and some event is arbitrarily assumed to be a final event, in accordance thereof, initial conditions, intermediate results and final results of processing of machine-readable information in the form of electronic documents are differentiated.

For initial conditions and intermediate results a specific group of actions is performed, including: formulating of objectives of processing, achieving of such objectives, formulating criteria and attributes for evaluating of achieving objectives, choosing a method of processing, performing of searching of methods and documents, defining of search queries, defining of criteria and attributes of matching of electronic documents to search queries, defining of criteria and attributes of matching of methods of processing of electronic documents to search queries, forming subject sets and subsets of electronic documents.

Examples of formulating of objectives of processing include ordering such as sorting in an ascending order of array elements, database record keys, words in a text file.

Examples of achieving of such objective include sorted in an ascending order array elements, and/or database record keys, words in a text file.

Examples of criteria of achieving of objective of sorting in an ascending order of array elements include comparing of sorted consecutive array elements and determining of each following array element as being larger than each preceding array element.

Examples of attributes of achieving objective of sorting in an ascending order of array elements include calculating of difference between consecutive pairs of array elements and comparing thereof to zero.

Examples of choosing of a method of sorting numerical array elements include choosing of any known algorithm of such sorting. Examples of choosing of a method include evaluating such as evaluating of speed of performing of an algorithm, and/or resources of computing time, and deciding on using any algorithm based on results of comparing results of evaluating of each algorithm such as speed of performing of an algorithm, and/or resources of computing time.

Examples of searching of an electronic document such as the smallest numerical array element sorted in an ascending order of element values include choosing of the first and the last element of such array, calculating differences thereof, comparing it to zero and determining of the smallest array element as a result. It comprises formulating search queries (searching of the smallest element), determining of criteria (comparing of at least two elements) and attributes (comparing of differences of two elements to zero) of matching of an electronic document (a numerical array element) to a search query.

Any intermediate or final results of processing of machine-readable information in the form of electronic documents are attributed to subject subsets.

In accordance with the invention, a computer-based method of processing of machine-readable information in the form of electronic documents is performed as follows:

At least one set of electronic documents such as database which can be located in internal or external computer memory, and in particular such set of electronic documents accessed by a computer via Internet, is called for with the help of a computer

At least one search query is defined of any kind (rubrics of classification, keywords in a text, parts of a text, author names, etc.)

Search attributes of electronic documents are matched with at least one defined search query.

Presence of search attributes relevant to at least one defined search query is determined.

Electronic documents relevant to one or more defined search queries are attributed to such subject subset of electronic documents or such subject subsets of electronic documents to which search query or search queries such electronic documents are relevant.

Each search query is matched one subject subset of electronic documents. Each such subject subset of electronic documents is biunique only to one search query.

Such subsets are formed as follows.

A subset of electronic documents such as a database is chosen for processing of machine-readable information.

A search query is defined in regard to machine-readable information in the form of electronic documents such as file properties, file formats, information contained in files, and/or methods of processing. A search query provides for finding of electronic documents with defined properties and/or contents within a subset of electronic documents.

If a search query defines creating of a list of all the files with TXT extension from the root directory of a hard drive, then all the files in that or another order are checked with all the files with TXT extension included in a list with names and addresses thereof. In this case, a search query contains only several letters from a file name. A search query directly and contextually defines this attribute.

In addition to the above-mentioned actions, any action or any combination thereof can be performed as follows.

Electronic documents relevant to one search query are attributed to a subject subset of electronic documents which search queries such electronic documents are relevant to.

Electronic documents relevant to more than one search query are attributed to each subject subset of electronic documents which search queries such electronic documents are relevant to, providing for existence of several subsets that can be treated separately such as being processed by various operators and/or various information systems.

A total number of non-empty subject subsets of electronic documents is calculated providing in particular for evaluating of efficiency of chosen search queries, clarifying as needed chosen search queries, and after several repeating storing statistic information.

A number of electronic documents attributed to each non-empty subject subset of electronic documents is calculated, providing in particular for evaluating of efficiency of chosen search queries, clarifying as needed chosen search queries and after several repeating storing statistic information.

Machine-readable information in the form of electronic documents contained in at least one subject subsets of electronic documents can be processed at least once again as described above. Additional processing of subject subsets of electronic documents of machine-readable information provides for evaluating of efficiency of chosen search queries, choosing the most efficient search queries, rejecting the least efficient search queries, clarifying as needed chosen search queries and after several repeating storing statistic information.

### Example 2

Processing of machine-readable information in the form of electronic documents accompanied by visualizing on a screen of intermediate and/or final results of such processing.

In example 2, a computer-based method of processing of machine-readable information in the form of electronic documents is initially performed as described in example 1 with following visualization on a screen of intermediate and/or final results of processing of machine-readable information.

Intermediate and/or final results of processing of machine-readable information have each non-empty subject subset of electronic documents visualized on a screen as a separate box. Each electronic document of such subject subset of electronic documents is visualized as an area within a corresponding box. Boxes and areas are rendered as separate objects of visualizing with properties which can be changed while being visualized.

Intermediate and/or final results of processing of machine-readable information can be visualized on a screen not only as a box but also as any visually isolated parts of a screen, with presentation of a part of substantial information to a user within separate visually isolated parts of a screen. For example to present there a table with a list of results, statistic information thereof.

Each and/or any representation of a subject subset of electronic documents is visualized on a screen as a separate visually isolated part of a screen which is biunique only to one such representation of a subject subset of electronic documents. This allows visualizing of operations with subsets and provides an additional possibility of establishing of and visualizing of links between subsets, for example by drawing of the lines of connections and by building a hierarchical structure of subsets.

Each and/or any representation of a subject subset of electronic documents is visualized on a screen as one or more boxes with each box being biunique to only one such representation of a subject subsets of electronic documents.

Each and/or any visually isolated part of a screen visualizing each representation of a subject subsets of electronic documents is assigned a symbol such as a title or a number, providing for sorting of subsets.

Each and/or any box can be assigned a symbol such as a title or a number.

The above-mentioned temporary symbol of each and/or any representation of a subject subset of electronic documents can be number thereof. In particular, the above-mentioned temporary symbol of a box can be number thereof in a part of a screen to which such box is assigned.

The above-mentioned temporary symbol of each and/or any representation of a subject subset of electronic documents can be coordinates thereof such as coordinates of location thereof in a part of a screen to which such representation of a subject subset of electronic documents is assigned.

The above-mentioned temporary symbol of a box can be coordinates thereof in a part of a screen to which such box is assigned.

Subject subsets of electronic documents can be visualized within a corresponding part of a screen as a table, such as providing for enhanced visualizing of hierarchical links between subsets.

Boxes can also be visualized within a corresponding part of a screen as a table.

Representations of subject subsets of electronic documents can be visualized on a screen within a separate visually isolated part of a screen, called a territory. Coordinates of borders of visualizing of representations of subject subsets of electronic documents can be calculated taking into account borders of a territory allocated for visualizing of representations of subject subsets of electronic documents. This provides a more complete filling of a screen with representations of subject subsets given that a part of a screen is always allocated for placing of other substantial information.

Boxes can be visualized on a screen within a separate visually isolated part of a screen, called a territory, given that coordinates of borders of boxes are calculated taking into account borders of a territory allocated for placing of boxes. This provides a more complete filling of a screen with boxes given that a part of a screen is always allocated for placing of other substantial information.

Each representation of an electronic document relevant to at least one search query and attributed to at least one subject subset of electronic documents can be visualized on a screen as a separate visually isolated part of a screen within a box, called areas, wherein (in box) all the representations of electronic documents attributed to such subject subset of electronic documents are visualized. These areas can easily change their shapes and sizes according to a chosen rule. This provides a more complete filling of a box and a compact representation of a single electronic document. Each area may contain a document address and/or call the execution of some procedures such as an opening of document for viewing, changing of document's properties, moving or deleting of document, and performing other actions with a document, it's properties, or with other processes and objects related to an electronic document visualized as an area within a box.

Each and/or any representation of an electronic document can be visualized on a screen within a box. Each from these boxes is biunique to representations of only electronic documents relevant to at least one search query and attributed to a subject subset of electronic documents corresponded to this search query.

Each and/or any representation of an electronic document can be visualized on a screen within one or more boxes. Electronic documents relevant to more than one search query are attributed to each subject subset of electronic documents, to search queries of which (subject subsets) such electronic documents are relevant and such representations of electronic documents visualized within each box to which such subject subsets of electronic documents are assigned. An area can be coded with much less volume of information than an electronic document contains itself. For example an area can be matched to an sequential number of a document among chosen as a result of processing of information, the information about an area can be coded with consecutive natural numbers but in the same time calling for an area can start complex scripts of processing of a particular electronic document. This provides a complete representation of electronic documents in all such subject subsets of electronic documents with low usage of memory, traffic, and other resources. The representation of an area can have a small size chosen as a result of a necessity of placing of a large number of areas within a part of a box allocated for it as well as requiring of complete filling of such part of a box with all the areas visualizing electronic documents attributed to a corresponding subject subset of electronic documents.

Borders of areas can be isolated by a color, a form, or other means as well as only coordinates of placing thereof within a box, the latter providing for a new property - a possibility of placing on one and the same fragment of a screen of areas and other information such as placing of areas visualizing electronic documents with phone numbers on a building plan with linking borders of areas and borders of premises with such phones located, excessive and/or repeating information about borders being excluded.

Each and/or any representation of an electronic document can be assigned a symbol such as a title or a number. The above-mentioned symbol of a representation of electronic document is number thereof in a box to which such representation of an electronic document is assigned.

The above-mentioned symbol of a representation of electronic document can be coordinates thereof within a box to which such representation of an electronic document is assigned.

Representations of electronic documents can be visualized in box as a table. All the representations of electronic document attributed to one and the same subject subset of electronic documents are better visualized as separate visually isolated parts of a screen within a corresponding box, called areas. It is appropriate to visualize all the representations of electronic document attributed to one and the same subject subset of electronic documents as separate visually isolated parts of a screen within a corresponding box, called areas. Coordinates of borders of areas can be calculated taking into account borders of a part of a box allocated for placing of areas.

All the representations of electronic document attributed to one and the same subject subset of electronic documents are visualized as separate visually isolated parts of a screen within a corresponding box, called areas. The above-mentioned areas can completely fill borders of at least part of a box allocated for placing of such areas.

Size of the above-mentioned areas can be design in such a way to allow for visualizing of only part of the above-mentioned areas within borders of a box. This part of the above-mentioned areas is visualized within borders of such box and other part of the above-mentioned areas which is not visualized within a box can be not visualized on a screen at all. However there is provided a possibility of moving of the above-mentioned areas for visualizing of any combination of the above-mentioned areas. There is provided a possibility of decreasing or increasing size of the above-mentioned areas during the processing of machine-readable information.

The above-mentioned areas fill borders of at least part of a box allocated for placing of areas in accordance with defined rules of placing of such areas within a box.

All the representations of electronic document attributed to one and the same subject subset of electronic documents are visualized within a corresponding box as separate visually isolated parts of a screen, called areas, given that areas fill borders of at least part of a box allocated for placing of areas in accordance with defined rules of placing of such areas within a box.

Size and borders of each area within borders of at least part of a box allocated for placing of areas are calculated taking into account borders of a box, a number of areas and defined rules of placing of such areas within a box. It provides creating a part of a box not filled with areas and placing of substantial information therein.

### Example 3

Processing of machine-readable information in the form of electronic documents accompanied by visualizing on a screen of intermediate and/or final results of such processing and using color codes.

In example 3, a computer-based method of processing of machine-readable information in the form of electronic documents is initially performed as described in example 1 with a possibility of further performing of actions as described in example 2. In addition, the following actions can be performed as follows.

Each electronic document and/or a representation of an electronic document is assigned a unique color code. Each electronic document and/or a representation of an electronic document can be assigned two or more uniquely combined color codes. Variants of matching of different images on a screen to unique color codes can also be realized as follows.

A unique color code or uniquely combined color codes are matched to each electronic document relevant to one or more defined search query and/or a representation of such electronic document.

A unique color code or uniquely combined color codes can also be matched only to electronic documents relevant to one or more defined search query and/or a representation of such electronic document.

Intermediate and/or final results of processing of machine-readable information are visualized on a screen with each area (each visually isolated part of a screen) visualizing a corresponding representation of an electronic document colored according to a unique color code assigned to such electronic document or uniquely combined color codes assigned to such electronic document and/or a representation of such electronic document.

At least one box is assigned a unique color code. Background of at least one box is assigned a unique color code. Borders of at least one box are assigned a unique color code.

A unique color code or uniquely combined color codes can also be matched various images on a screen without coloring them. However they can be actually colored accordingly.

Intermediate and/or final results of processing of machine-readable information are visualized on a screen with background and/or borders of at least one box colored according to at least one unique color code assigned to such box.

Each subject subset of electronic documents can be assigned a unique color code.

Each subject subset of electronic documents can be assigned two or more uniquely combined color codes.

Each unique color code can be matched to each non-empty subject subset of electronic documents.

A unique color code or uniquely combined color codes can also be matched only to non-empty subject subsets of electronic documents.

Areas visualizing corresponding representations of electronic document relevant to at least one from defined search queries can be colored in corresponding colors during the visualization on the screen of intermediate and/or final results of processing of machine-readable information.

If a set of electronic documents called for in the process of processing of machine-readable information is a database, each record thereof can be assigned a unique color code or at least two uniquely combined color codes.

Representations of electronic documents visualized on a screen within visually isolated parts of a screen, called areas, can also be not isolated according to a color of such area, and/or a color of borders thereof, and/or visually discernible titles within such areas. Such areas are differentiated from other similar areas only by coordinates of borders thereof and/or a location thereof within a box.

An area visualized on a screen in a visually isolated part of a screen within a box can be not isolated according to a color of such area, and/or a color of borders thereof, and/or visually discernible titles within such areas. Such area is differentiated from other similar areas only by coordinates of borders thereof and/or a location thereof within a box.

In the method, matching of a unique color code or unique combination of color codes to differentiated objects provides for easy and quick selecting of a corresponding object, storing of a comparatively small information volume equivalent to a state (meaning that with the help of which such state can be reproduced) of an initial set of electronic documents as well as results of its processing, visualizing, and further additional processing and visualizing, and performing of some operations not with objects themselves but color codes thereof as needed.

### Example 4

Processing of machine-readable information in the form of electronic documents with the help of automatic actions and/or operator-defined commands.

In example 4, a computer-based method of processing of machine-readable information in the form of electronic documents can be performed as described in examples from 1 to 3. Some actions can be performed as follows.

Intermediate or final results of processing of machine-readable information visualized on a screen as areas within boxes and visualizing representations of electronic documents relevant to at least one defined search query can be selected by positioning of one from available cursors over such areas and performing of previously defined commands while positioning of a cursor in an operator-defined sequence for a visualized viewing of at least part of information contained in electronic documents, and/or at least part of properties of corresponding electronic documents, and/or performing of a previously defined sequence of actions with corresponding electronic documents, which representations are visualized by such areas.

A visualized viewing of at least part of information contained in any such electronic document, and/or at least part of properties of a corresponding electronic document, and/or performing of a previously defined sequence of actions with a corresponding electronic document can be automatically moved to each consequent area within a box visualizing a representation of other electronic document after an operator-defined time interval.

An automatic move can be performed to a consequent area visualizing a representation of an electronic document by order or to an area visualizing a representation of an electronic document by other operator-defined choice rule such as to previously viewed areas.

An automatic move after an operator-defined time interval to a consequent area visualizing a representation of an electronic document can be paused and/or continued by an operator command such as pressing a certain key on a keyboard.

An automatic move to a consequent area visualizing a representation of an electronic document by an operator command can be paused and/or continued, and/or have direction of a visualized viewing changed, and/or have time interval changed for an automatic move to a consequent area visualizing a representation of an electronic document, and/or have rule of choice changed for a consequent area visualizing a representation of an electronic document, and/or have subject changed for visualizing of information related to an electronic document, and/or have a previously defined sequence of actions with corresponding electronic document changed. For example keys on a keyboard that control the cursor movement can define moves to consequent areas.

At least part of information contained in an electronic document chosen by an operator for a visualized viewing can be visualized within a special visually isolated part of a screen.

Information contained in an electronic document chosen by an operator for a visualized viewing can be visualized within a special visually isolated part of a screen in a previously defined scope for a visualized viewing.

At least part of information contained in an electronic document chosen for viewing can be visualized within a special visually isolated part of a screen in a previously defined format.

At least part of information contained in an electronic document chosen for a visualized viewing can be retrieved from a previously defined part of an electronic document in a previously defined scope and visualized on a screen in a previously defined format within a special visually isolated part of a screen for a visualized viewing.

Any visualized on a screen as areas within boxes, visually isolated parts of a screen, intermediate or final results of processing of machine-readable data, representations of electronic documents relevant to at least one defined search query can be accompanied with the help of positioning of one from available cursors over the chosen area, such as chosen by an operator, by the following actions or any combination of the following actions:

viewing of at least part of information contained in any such document in a previously defined scope and in a previously defined format of a presentation of this information within a special visually isolated part of a screen, such as viewing of a title of a text contained in an electronic document,

viewing of any such document, such as calling for a full-screen viewing thereof,

viewing of properties of any such document, such as viewing of extensions of files,

attributing of at least one additional property to any such document, such as adding an attribute of attributing to a given subject subset of electronic documents,

modifying of at least one property of any such document, such as changing of an attribute of attributing to a given subject subset of electronic documents to an attribute of excluding from such subject subset of electronic documents as a result of viewing of contents of a document,

copying of a representation of any such document, such as for forming an operator selection of viewed documents,

duplicating of a representation of any such document, such as for inclusion of several copies of an electronic document to a subject subset of electronic documents being viewed,

moving of a representation of any such document, such as for dividing of one subset into several subsets,

deleting of a representation of any such document, such as excluding of electronic document not substantial for further processing of information.

Choosing of at least one visualized on a screen as areas within a box, visually isolated parts of a screen, intermediate or final results of processing of machine-readable information, electronic documents relevant to at least one defined search query can be performed with the help of positioning of one from available cursors over a corresponding area within a box assigned for a chosen result and/or a representation of an electronic document.

Positioning of one from available cursors can be performed within a previously operator-defined time interval.

Choosing can be performed by positioning of one from available cursors and pressing a previously defined key on a keyboard.

Choosing can be performed by positioning of one from available cursors and pressing a previously defined mouse button.

Choosing can be performed by positioning of one from available cursors and pressing a previously defined key or a combination of keys on a previously defined manipulator.

At least part of properties of an electronic document chosen by an operator for a visualized viewing can be visualized within a special visually isolated part of a screen.

Information about properties of an electronic document chosen by an operator for a visualized viewing can be visualized within a special visually isolated part of a screen in a previously defined scope for a visualized viewing.

At least part of properties of an electronic document chosen by an operator for viewing can be visualized within a special visually isolated part of a screen in a previously defined format.

At least part of properties of an electronic document chosen for a visualized viewing can be retrieved from previously defined part of an electronic document and/or other source of information about properties of a chosen electronic document in a previously defined scope and visualized within a special visually isolated part of a screen in a previously defined format for a visualized viewing. This provides the reasonable decreasing of information transmitted via communication channels and accelerating of such transmitting and reproducing of such information for a visualized viewing.

Intermediate and/or final results of processing of machine-readable information can be visualized on a screen with each non-empty subject subset of electronic documents as a box and each electronic document of such subject subset of electronic documents as a separate area within a corresponding box. Each electronic document of such subject subset can be visualized as a separate area within a corresponding box, given that boxes and areas are rendered as separate visualized objects having properties thereof changed while being visualized.

Intermediate and/or final results of processing of machine-readable information can be visualized on a screen with showing each non-empty subject subset given that a list of empty subject subsets also provides substantial information about absence of electronic documents relevant to a search query presented by simpler methods such as a table or a text. Information about empty and non-empty sets and subsets of electronic documents is always among results of processing of information, such as absence of a file relevant to a search query can be visualized by simpler method, such as defining of “no file”. Defining of presence of a text file in an electronic library requires larger resources for processing of information and visualizing of results.

In the description, there are provided preferable variants of using of the invention, however, for specialists in this field of technology it is clear that other various modifications of the invention as well as adding and changing of various attributes of the invention without departing from scope and spirit of the invention are possible.

1-76. (canceled)

77. A computer-based method of processing of machine-readable data which are represented as electronic documents, comprising:
Calling for at least one set of electronic documents;
Specifying at least one search query;
Matching of search attributes of electronic documents to at least one specified search query;
Determining of the presence of search attributes in these electronic documents that correspond to each specified search query;
Matching of each search query to its own unique subject subset of electronic documents given that only one search query is biunique to each of these subject subsets of electronic documents;
Attributing of the electronic documents relevant to any specified search query to such subject subsets of electronic documents, to search queries of which these electronic documents are relevant.

78. The method of claim 77, wherein the electronic documents relevant to more than one search query are attributed to each subject subset of electronic documents to search queries of which these electronic documents are relevant.

79. The method of claim 77, wherein the results of processing of machine-readable data are visualized on screen with each non-empty subject subset of electronic documents as a separate box and each electronic document attributed to such subject subset of electronic documents as a separate area in a corresponding box, given that boxes and areas are rendered as separate visualized objects having their properties, which can be changed while being visualized.

80. The method of claim 79, wherein any representation of subject subset of electronic documents is visualized on screen as boxes given that only one of such representations of subject subsets of electronic documents is biunique to each of such boxes.

81. The method of claim 77, wherein the representations of the subject subsets of electronic documents are visualized on screen in a separate visually isolated screen part, called territory, given that coordinates of borders for visualization of representations of subject subsets of electronic documents are calculated taking into account the borders of the territory allocated for visualization of the representations of subject subsets of electronic documents.

82. The method of claim 79, wherein a representation of an electronic document is visualized on screen in boxes given that the electronic documents relevant to more than one search query are attributed to each subject subset of electronic documents to search queries of which these electronic documents are relevant, and these representations of electronic documents are visualized in each box corresponding to such subject subsets of electronic documents.

83. The method of claim 79, wherein the representations of electronic documents are visualized in a box as a table.

84. The method of claim 79, wherein all the representations of electronic documents attributed to the same subject subset of electronic documents are visualized in a corresponding box as separate visually isolated screen parts, called areas, given that coordinates of the borders of areas are calculated taking into account the borders of space in a box allocated for visualizing of areas.

85. The method of claim 79, wherein the borders of the above-mentioned areas are rendered so that the above-mentioned areas are visualized partly when part of above-mentioned areas is visualized within the box borders and another part of the above-mentioned areas not rendered within the box borders is not visualized on screen given that any combinations of the above-mentioned areas can be visualized within the borders of such box by moving the above-mentioned areas.

86. The method of claim 79, wherein the above-mentioned areas fill at least part of space in a box allocated for such areas according to a specified rule of placement for such areas in a box.

87. The method of claim 79, wherein all the representations of electronic documents attributed to one and the same subject subset of electronic documents are visualized in a corresponding box as separate visually isolated screen parts, called areas, given that such areas fill at least part of space in a box allocated for visualizing of such areas according to specified rules of placement for such areas in a box.

88. The method of claim 77, wherein each electronic document is assigned at least one unique color code.

89. The method of claim 88, wherein each electronic document is assigned at least two uniquely combined color codes.

90. The method of claim 77 wherein each electronic document relevant to a specified search query is assigned at least one unique color code.

91. The method of claim 77, wherein each subject subset of electronic documents is assigned a unique color code.

92. The method of claim 91, wherein each subject subset of electronic documents is assigned at least two uniquely combined color codes.

93. The method of claim 79, wherein the results of processing of machine-readable data are visualized on screen with areas in boxes and visualized representations of the electronic documents relevant to at least one specified search query selected by positioning of the available cursor over such areas and performing previously defined commands while positioning the cursor in an operator-defined sequence for visualized viewing of at least part of information contained in the electronic documents.

94. The method of claim 93, wherein during the visualized viewing of at least part of information contained in any of such electronic documents the automatic move to each next area in a box visualizing the next representation of the electronic document is performed after operator-defined time intervals.

95. The method of claim 94, wherein the automatic move to the next area visualizing a representation of an electronic document is performed after an operator-defined time interval.

96. The method of claim 93, wherein the information contained in an electronic document chosen for visualized viewing by an operator is visualized on a special visually isolated screen part in a previously defined scope for visualized viewing.
